(19) United States
(12) Patent Application Publication
(10) Pub. No.: US 2026/0246152 A1
(43) Pub. Date: Aug. 20, 2026

(54) PHOTONIC ANTENNA OPERATING IN 275-296 GIGAHERTZ

(71) Applicant: Beijing University of Posts and Telecommunications, Beijing (CN)

(72) Inventors: Jianguo Yu, Beijing (CN); Yun Wang, Beijing (CN); Kaile Li, Beijing (CN); Xiaorui Liu, Beijing (CN); Yibo Huang, Beijing (CN); Ruizi Li, Beijing (CN); Yaqi Cheng, Beijing (CN); Zhihe Wu, Beijing (CN)

(21) Appl. No.: 19/324,711

(22) Filed: Sep. 10, 2025

(30) Foreign Application Priority Data
Feb. 17, 2025 (CN) 2025101693693

(51) Int. Cl. H01Q 13/08

(52) U.S. Cl. CPC H01Q 13/085

(57) ABSTRACT

A photonic antenna operating in 275-296 gigahertz is provided. The antenna includes two uni-traveling-carrier photodetectors (UTC-PDs) and a passive structure. Each UTC-PD employs a double-mesa structure. Each UTC-PD have electrodes routed via electroplated micro-pads, with each electroplated micro-pad processed with the metallic bumps. The UTC-PDs are electrically connected to the passive structure by flip-chip bonding. The passive structure includes impedance matching circuits, a power combiner, and a Vivaldi antenna. Each UTC-PD generates signals, and an absorption layer introduces a built-in electric filed by gradient-doping. A cliff layer is disposed between the absorption layer and a collection layer. The impedance matching circuit ensure that the output impedance of the UTC-PD approaches 50Ω, the power combiner superposes the two signals onto a feeding terminal of the Vivaldi antenna, whereupon the signals are converted into high-frequency electromagnetic waves in the 275-296 gigahertz band and radiated.

### CROSS-REFERENCE TO RELATED APPLICATION

This application claims priority to Chinese Patent Application No. 202510169369.3, filed on Feb. 17, 2025. The entire contents of the above-mentioned application are incorporated herein by reference.

### TECHNICAL FIELD

The disclosure relates to the technical fields of optoelectronics and terahertz communications, and more particularly to a photonic antenna operating in 275-296 gigahertz (GHz).

### BACKGROUND

Terahertz (THz) technology, owing to its unique frequency range of 0.1-10 THz, presents broad prospects in fields such as broadband wireless communications, spectral analysis, security imaging, and biomedical diagnostics. Compared with traditional optical and microwave technologies, THz waves exhibit advantages such as strong penetrability, moderate wavelength, and non-ionizing characteristics, thereby enabling unique functionalities in high-resolution imaging and precise spectral identification. As a result, this band is hailed as “the core frequency band of future technologies.”

In the THz frequency band, conventional transistor technologies struggle to satisfy high-frequency requirements; especially above 100 GHz, where the cut-off frequency and power gain of transistors decay rapidly. Consequently, photodetectors have become key components in the field of the THz technology, which are required to possess characteristics such as high speed, high responsivity, and high saturation output.

Traditional positive-intrinsic-negative (PIN) photodetectors are limited by space-charge effect and therefore cannot meet the demands for high bandwidth and power output. In contrast, uni-traveling-carrier photodetector (UTC-PD), through optimized design, fully utilizes electrons as the sole carriers, and its photodetection performance has been significantly enhanced in terms of bandwidth and response speed.

By virtue of its characteristics of high speed, high responsivity, and weak space-charge effect, the UTC-PD has become a research focus in the field of optoelectronic devices. However, conventional UTC-PD designs still face bottlenecks in integrability, impedance matching efficiency, and consistency of power output, which hinder their widespread application in higher frequency bands (e.g., 275-296 GHz).

### SUMMARY

The disclosure provides a photonic antenna operating in 275-296 gigahertz (GHz). Through a monolithic integration design, optimized impedance matching circuits, an integrated high-efficiency power combiner, and a broadband antenna of inventive design, the antenna enables efficient generation and transmission of signals within the terahertz range. By leveraging the performance advantages of the photodetector and the advanced processes of integrated-circuit fabrication, the disclosure furnishes a new solution for 275-296 GHz terahertz communications and related applications.

The photonic antenna operating in 275-296 GHz includes uni-traveling-carrier photodetectors (UTC-PDs) and a passive structure. The passive structure including impedance matching circuits, a power-combiner, and a Vivaldi antenna.

The UTC-PDs are two in quantity, each UTC-PD adopts a double-mesa structure, the two identical UTC-PDs each have electrodes routed via electroplated micro-pads, with each electroplated micro-pad processed with metallic bumps. The UTC-PDs are electrically connected to the passive structure fabricated on a quartz substrate by flip-chip bonding.

In an embodiment, the double-mesa structure of each UTC-PD includes: a P-type ohmic-contact layer, a barrier layer, an absorption layer, and a collection layer sequentially arranged in that order from top to bottom.

The barrier layer includes a P-type indium phosphide (InP) barrier layer and a P-type indium gallium arsenide phosphide (InGaAsP) barrier layer.

The absorption layer includes a P-type heavily-doped non-depleted indium gallium arsenide (InGaAs) absorption layer and a P-type doped depleted InGaAs absorption layer. The absorption layer introduces a built-in electric field through gradient-doping, a concentration difference induces a potential difference to introduce a high electric field to accelerate electrons transport through the absorption layer.

The collection layer includes an N-type doped InP cliff layer and an N-type lightly-doped InP collection layer. The InP cliff layer enhances the electric field in the absorption layer while reducing the electric field in the collection layer.

In an embodiment, the two UTC-PDs respectively correspond to the impedance matching circuits, the impedance matching circuits are two in quantity and arranged symmetrically. Each impedance matching circuit adjusts an output impedance of each UTC-PD to be close to 50 ohms (Ω) within the 275-296 GHz, optimizing a power transmission efficiency and minimizing a reflection loss in the frequency band.

In an embodiment, the impedance matching circuits are fabricated on the quartz substrate with a relative dielectric constant of 3.78. Each impedance matching circuit includes a serial transmission line, a short-circuited stub line, and a metal-insulator-metal (MIM) capacitor, wherein both the serial transmission line and the short-circuited stub line are implemented in coplanar waveguide configuration.

In an embodiment, a load impedance of each UTC-PD is adjusted to be close to 50Ω; and specific calculation formulas include:
an output impedance of each UTC-PD in a certain frequency band is: Z=m+j×n;
where m is resistance, n is reactance, and j is imaginary unit;
an impedance of each impedance matching circuit is: Z1=α+j×c;
where a is resistance, and c is reactance.

Impedance matching is calculated by: making the output impedance Z and the impedance Z1 satisfy: Z+Z1=50+j×0, that is, an output resistance of the UTC-PD with the impedance matching circuit superimposed in the certain frequency band is 50Ω and the reactance is zero.

In an embodiment, the power-combiner is a T-junction power combiner used after the impedance matching circuits to superimpose two impedance-matched signals, where two input terminals (also referred to a first terminal and a second terminal) of the power combiner respectively correspond to output terminals of the two impedance matching circuits.

In an embodiment, the T-junction power combiner includes: the input terminals (also referred to the first terminal and the second terminal) each with a length of 10 micrometers (μm) and a characteristic impedance of 50Ω; a quarter-wavelength impedance transforming part with a length of 177 μm and a characteristic impedance of 70.7Ω; and a third terminal with a length of 30 μm and a characteristic impedance of 50Ω.

The Vivaldi antenna is connected to the third terminal of the T-junction power combiner. The Vivaldi antenna is fed by a coplanar waveguide to directly radiate terahertz signals into a free space while maintaining a high gain.

In an embodiment, the Vivaldi antenna includes a feeding terminal, a radiating structure, and a reflecting structure.

The feeding terminal adopts a coplanar waveguide structure, which is identical to a structure of a terminal of the T-junction power combiner.

The radiating structure includes an exponentially changing open structure, radiating sheets of the Vivaldi antenna are defined with slots to enhance gain, and metal blocks are disposed at a middle position of a dielectric substrate to direct. The reflecting structure in an arc shape is formed on a rear surface of the dielectric substrate to reduce a rear lobe gain and a side lobe gain.

In an embodiment, a width of each slot is 30 μm, a spacing between the slots is 100 μm, and a height of the slot decreases in units of 50 μm starting from 200 μm.

In an embodiment, a specific working principle of the photonic antenna is as follows.

The UTC-PDs of the photonic antenna are configured to generate signals. An absorption layer is configured to introduce a built-in electric field through gradient-doping to accelerate movement of electrons within the absorption layer. A cliff layer located between the absorption layer and a collection layer is configured to enhance the electric field in the absorption layer while reducing an electric field in the collection layer. Each impedance matching circuit are configured to ensure that an output impedance of each UTC-PD is close to 50Ω in the 275-296 GHz after the signals passes through the impedance matching circuit, so as to obtain impedance-matched signals from the two UTC-PDs. The power combiner is configured to superimpose the impedance-matched signals onto a feeding terminal of the Vivaldi antenna. Finally, the Vivaldi antenna is configured to convert signals received by the feeding terminal of the Vivaldi antenna into electromagnetic waves in the 275-296 GHz to radiate.

The advantages of the disclosure are as follows.

(1) The photonic antenna operating in 275-296 GHz adjusts the load impedance of the UTC-PD to approximately 50Ω within the 275-296 GHz by means of the impedance matching circuit, thereby optimizing power-transfer efficiency and minimizing reflection loss.

(2) The photonic antenna operating in 275-296 GHz employs the T-junction power combiner to superpose the two impedance-matched signals while maintaining a comparatively low reflection coefficient at the resonant frequency point.

(3) In the photonic antenna operating in 275-296 GHz, the Vivaldi antenna is connected to the output of the power combiner to radiate the THz signal directly into the free space with a high gain.

(4) In the photonic antenna operating in 275-296 GHz, the two UTC-PDs each having the P-mesa (i.e., the double-mesa structure) with a diameter of 3 μm, together with the micro-pads are integrated with the passive structure fabricated on the quartz substrate by flip-chip bonding. Fabricating the passive structure on the quartz substrate rather than on an InP wafer increases utilization of the InP wafer, allows independent optimization of the active device UTC-PDs and the passive structure, and reduces experimental cost.

### BRIEF DESCRIPTION OF DRAWINGS

FIG. 1 illustrates a schematic perspective structural view of a photonic antenna operating in 275-296 GHz according to the disclosure.

FIG. 2 illustrates a top view of the photonic antenna operating in 275-296 GHz according to the disclosure.

FIG. 3 illustrates a schematic view of impedance matching circuits and a power combiner module according to the disclosure.

FIG. 4 illustrates a schematic view of a Vivaldi antenna according to the disclosure.

FIG. 5 illustrates a schematic view of a rear reflection structure of the Vivaldi antenna according to the disclosure.

FIG. 6 illustrates a schematic curve diagram of reflective coefficient changing with frequency after a power combining circuit is integrated with front-end impedance matching circuits and a uni-traveling-carrier photodetector (UTC-PD) according to the disclosure.

FIG. 7A illustrates an E-plane radiation pattern of the Vivaldi antenna according to the disclosure.

FIG. 7B illustrates a three-dimensional radiation pattern of the Vivaldi antenna according to the disclosure.

FIG. 8A illustrates an E-plane radiation pattern of the photonic antenna according to the disclosure.

FIG. 8B illustrates a three-dimensional radiation pattern of the photonic antenna according to the disclosure.

FIG. 9 illustrates a schematic curve diagram of gain changing with frequency of the photonic antenna according to the disclosure.

FIG. 10 illustrates a top view of a part of the photonic antenna operating in 275-296 GHz according to the disclosure.

FIG. 11 illustrates a schematic view of a double-mesa structure of the photonic antenna operating in 275-296 GHz according to the disclosure.

### DESCRIPTION OF REFERENCE SIGNS

1—UTC-PD; 2—impedance matching circuit; 3—power combiner; 4—Vivaldi antenna; 5—quartz substrate; 6—metallic bump; 8—P-type ohmic-contact layer; 9—barrier layer; 10—absortion layer; 11—collection layer; 12—serial transmission line; 13—short-circuited stub line; 14—metal-insulator-metal capacitor; 15—feeding terminal; 16—radiating structure; 17—reflecting structure; 18—metal block; 19—open structure; 20—radiating sheet; 21—slot; 22—first terminal; 23—second terminal; 24—third terminal; 25—electroplated micro-pad; 26—P-type InP barrier layer; 27—P-type InGaAsP barrier layer; 28—P-type heavily doped non-depleted InGaAs absorption layer; 29—P-type doped depleted InGaAs absorption layer; 30—N-type doped InP cliff layer; 31—N-type lightly-doped InP collection layer; 32—T-junction power combiner; 33—rear surface; 34—photonic antenna operating in 275-296 gigahertz; 35—output terminal.

### DETAILED DESCRIPTION OF EMBODIMENTS

The disclosure will be further described in detail below in conjunction with the accompanying drawings and embodiments.

The disclosure relates to a photonic antenna 34 operating in a frequency band of 275-296 gigahertz (GHz), which integrates uni-traveling-carrier photodetectors (UTC-PDs) 1, impedance matching circuits 2, a power combiner 3, and a Vivaldi antenna 4 through a monolithic integration process to generate and transmit electromagnetic waves in a terahertz frequency range. In this situation, the photonic antenna 34 achieves technical performances of a high bandwidth, a high gain, and a low insertion loss. The disclosure significantly enhances the generation and transmission efficiency of terahertz signals, ranging from 275 to 296 GHZ, offers advantages including high integration, stable performance, and strong reliability, as well as significance in promoting development of terahertz communication technologies, and expands applications of the terahertz communication in fields such as high-speed communications, precision measurement, and biomedical engineering.

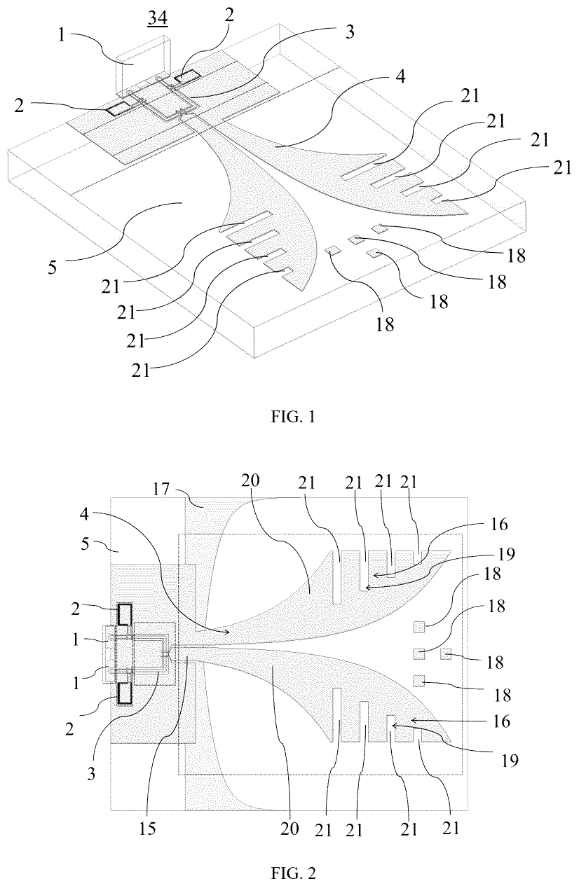

The photonic antenna 34 operating in 275-296 GHZ, as shown in FIG. 1 and FIG. 2, includes four parts: the UTC-PDs 1, the impedance matching circuits 2, the power combiner 3, and the Vivaldi antenna 4.

The UTC-PDs 1 are provided two in quantity; each adopts a double-mesa structure. A diameter of a P-mesa is 3 micrometers (μm). As shown in FIG. 11 and an epitaxy of the P-mesa includes: a P-type ohmic-contact layer 8, a barrier layer 9, an absorption layer 10 and a collection layer 11 sequentially arranged in that order from top to bottom.

The barrier layer 9 includes a P-type indium phosphide (InP) barrier layer 26 and a P-type indium gallium arsenide phosphide (InGaAsP) barrier layer 27.

The absorption layer 10 includes a P-type heavily-doped non-depleted indium gallium arsenide (InGaAs) absorption layer 28 and a P-type doped depleted InGaAs absorption layer 29. The absorption layer 10 adopts gradient-doping to introduce a built-in electric field. A concentration difference induces a potential difference that introduces a high electric field to accelerate electrons transport through the absorption layer. According to Poisson's Equation:

$${∇}^{2} φ = - \frac{ρ}{ε} ,$$

where φ is electric potential, ρ is charge density, and ε is permittivity. Thus a gradient change of doping concentrations affects the charge density and thereby generating the potential difference.

The collection layer 11 includes an N-type doped InP cliff layer 30 (also referred to a cliff layer 30) and an N-type lightly-doped InP collection layer 31. The InP cliff layer 30 changes an internal electric field distribution inside the UTC-PD 1, extending the electric field toward an absorption region, resulting in a lower electric field in a collection region than without the N-type doped InP cliff layer 30. This is because when a fixed reverse bias voltage is applied to the UTC-PD 1, an increase in an electric field intensity in a certain part of the UTC-PD 1 necessarily causes a decrease in other parts. Accordingly, the electric field in the absorption layer 10 is enhanced while the electric field in the collection layer 11 is reduced.

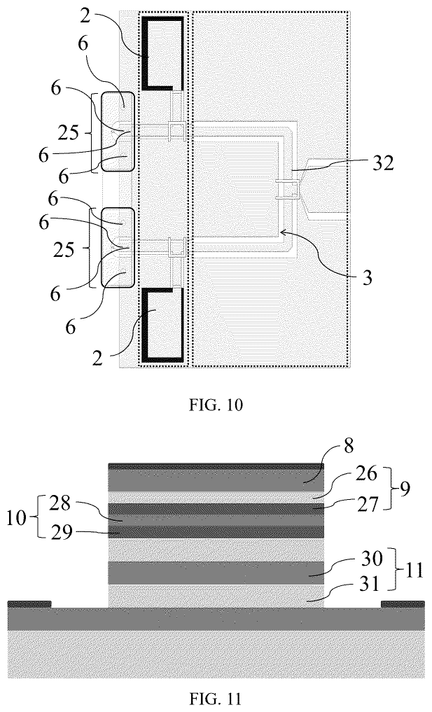

As shown in FIG. 10, the two UTC-PDs 1 have identical epitaxial structures. Electrodes are led out through two electroplated micro-pads 25. The metallic bumps 6 are formed on each of the micro-pad 25, and the UTC-PDs 1 are electrically connected to the passive structure fabricated on a quartz substrate 5 (also referred to a dielectric substrate) by flip-chip bonding. The passive structure includes impedance matching circuits 2, the power combiner 3, and the Vivaldi antenna 4.

The two UTC-PDs 1 respectively correspond to the two completely symmetrical impedance matching circuits 2. By means of the impedance matching circuit 2, within the 275-296 GHz band an output impedance of the UTC-PD 1 is adjusted to be close to 50 ohms (Ω), and the power transmission efficiency can be optimized and the reflection loss can be minimized. The specific calculations are as follows.

The output impedance of each UTC-PD 1 in a certain frequency band is: Z=m+j×n; where m is resistance, and n is reactance, the units of each is Q, and j is imaginary unit. An impedance of each impedance matching circuit 2 is: Z1=α+j×c, where α is resistance and c is reactance.

The impedance matching is calculated as follows. The impedance Z and Z1 satisfy: Z+Z1=50+j×0, that is, the output impedance of the UTC-PD 1 with the impedance matching circuit 2 superimposed is 50Ω in the frequency band, and the reactance is zero.

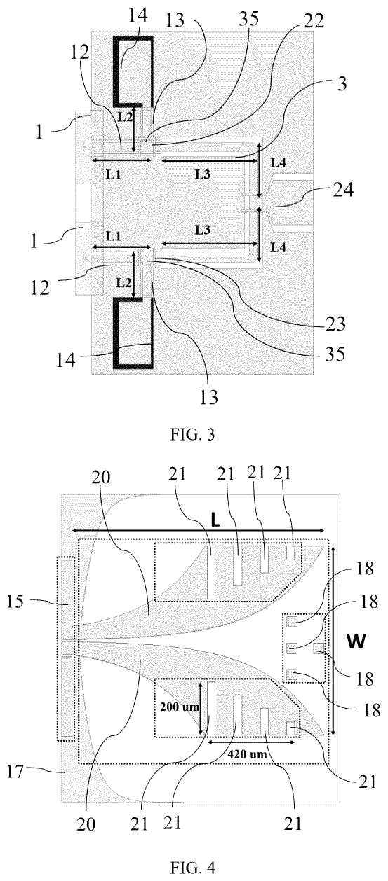

Although an output power of the UTC-PD 1 in the band can be improved by adopting the impedance matching circuit 2, the improvement is limited. Therefore, a T-junction power combiner 32 is employed after the impedance matching circuits 2 to superpose the two impedance-matched signals. A first terminal 22 and a second terminal 23 (also referred to two input terminals) of the power combiner 3 respectively correspond to two output terminals 35 of the two impedance matching circuits 2. As shown in FIG. 3, L₁ denotes a length of a serial transmission line 12 in the impedance matching circuit 2, L₂ denotes a length of a short-circuit stub line 13 in the impedance matching circuit 2. L₃ and L₄ belong to an impedance transforming part of the power combiner 3, and the sum of the L₃ and the L₄ is close to a quarter wavelength.

The Vivaldi antenna 4 is connected to a third terminal 24 of the power combiner 3. The Vivaldi antenna 4 is fed by a coplanar waveguide to radiate terahertz signals directly into a free space while maintaining a high gain. The structure of the Vivaldi antenna 4 is illustrated in FIG. 4, where L is a length of a radiating structure 16 and W is an opening width of the radiating structure 16.

The impedance matching circuits 2 are fabricated on the quartz substrate 5 with a relative permittivity of 3.78, each including the serial transmission line 12, the short-circuited stub line 13, and a metal-insulator-metal (MIM) capacitor 14. Among them, both the serial transmission line 12 and the short-circuit stub line 13 are implemented in coplanar waveguide configuration with a characteristic impedance of 50Ω. The dielectric layer of the MIM capacitor 14 is SiNₓ.

The T-junction power combiner 32 includes three parts: the first terminal 22 and the second terminal 23 (the input terminals) each with a length of 10 μm and a characteristic impedance of 50Ω; the quarter-wavelength impedance transforming part with a length of 177 μm and a characteristic impedance of 70.7Ω; and the third terminal 24 with a length of 30 μm and a characteristic impedance of 50Ω.

The Vivaldi antenna 4 includes a feeding terminal 15, the radiating structure 16, and a reflecting structure 17. The feeding terminal 15 adopts a coplanar-waveguide structure identical to the third terminal 24 of the T-junction power combiner 32. The radiating structure 16 includes exponentially changing open structure 19. To increase gain, radiating sheets 20 (also referred to radiating arms) of the Vivaldi antenna 4 are defined with slots 21 and metal blocks 18 are added at a middle position of the quartz substrate 5 to direct. To reduce the back lobe and side lobe gain, the reflecting structure 17 in an arc shape is formed on the rear surface 33 of the quartz substrate 5. The reflecting structure 17 is as shown in FIG. 5.

The slots 21 are defined on radiating sheets 20. A width of each slot 21 is 30 μm, a spacing between the slots 21 is 100 μm, and a height of the slot 21 decreases in units of 50 μm starting from 200 μm.

A working principle of the photonic antenna operating in 275-296 GHz 34 is as follows.

The UTC-PDs 1 of the photonic antenna 34 generate signals. The absorption layer 10 introduces a built-in electric field through gradient-doping to accelerate movement of the electrons in the absorption layer 10, thereby enhancing photoelectric-conversion efficiency. The cliff layer 30 located between the absorption layer 10 and the collection layer 11 enhances the electric field in the absorption layer 10 while reducing the electric field in the collection layer 11, optimizing carrier flow and reducing energy loss. The impedance matching circuit 2 ensure that the output impedance of the UTC-PD 1 is close to 50Ω in the 275-296 GHz after the signals passes through the impedance matching circuit 2, so as to maximize power transfer and minimize reflection loss. Next, the power combiner 3 superposes the two output signals of signal sources of the UTC-PDs 1 that each combined with the impedance matching circuit 2 onto the feeding terminal 15 of the Vivaldi antenna 4, increasing the overall output power of the system. Finally, the signals are converted into high-frequency electromagnetic waves in the 275-296 GHz band to radiate by the Vivaldi antenna 4, achieving efficient signal transmission. The design is suitable for high-frequency communication, radar detection, and other applications, improving system performance and signal-transmission efficiency.

### EMBODIMENT

The disclosure uses high frequency structure simulator (HFSS) for electromagnetic simulation. The simulation environment includes a substrate model based on quartz (with a relative permittivity of 3.78) and circuit-matching structures, and an operating band of 275-296 GHz. The specific steps are as follows.

Step 1: The UTC-PD 1 employs a double-mesa structure. The P-mesa with a diameter of 3 μm effectively optimizes resistance-capacitance (RC) time constant and increases electron migration velocity. Under a 3 volts (V) reverse bias, an electric field in a device depletion region is 20-40 kilovolts per centimeter (kV/cm), and electron transit-time bandwidth reaches 325 GHz.

Step 2: An impedance matching circuit 2 includes a serial transmission line 12, a short-circuit stub line 13, and a MIM capacitor 14.

A length L₁ of the serial transmission line 12 is 75 μm, and a length L₂ of the short-circuit stub line 13 is 43 μm. Both the serial transmission line 12 and the short-circuit stub line 13 are implemented in coplanar waveguide configuration with a characteristic impedance of 50Ω. A dielectric layer of the MIM capacitor is SiNₓ with thickness of 0.2 μm.

Step 3: A T-junction power combiner 32 includes input terminals (a first terminal 22 and a second terminal 23), a quarter-wavelength impedance transforming part, and a third terminal 24.

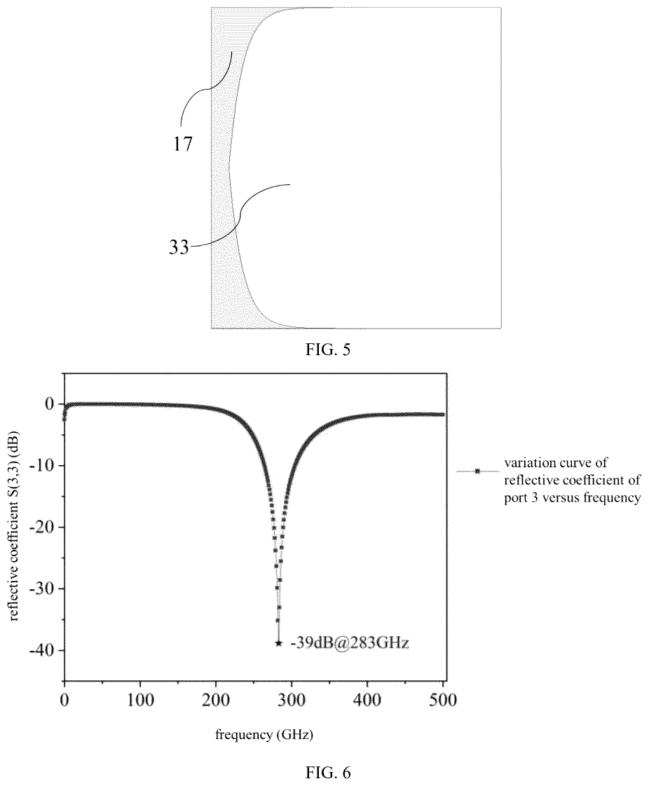

A length of the impedance transforming part is a sum of L₃ and L₄, which is 177 μm. The T-junction power combiner 32 resonates at 285 GHz after integrating with the preceding impedance matching circuits 2 and the UTC-PDs 1, and a reflective coefficient of the T-junction power combiner 32 is below −39 decibels (dB). As shown in FIG. 6, the T-junction power combiner 32 effectively combines the signals from the two UTC-PDs 1 after impedance matching.

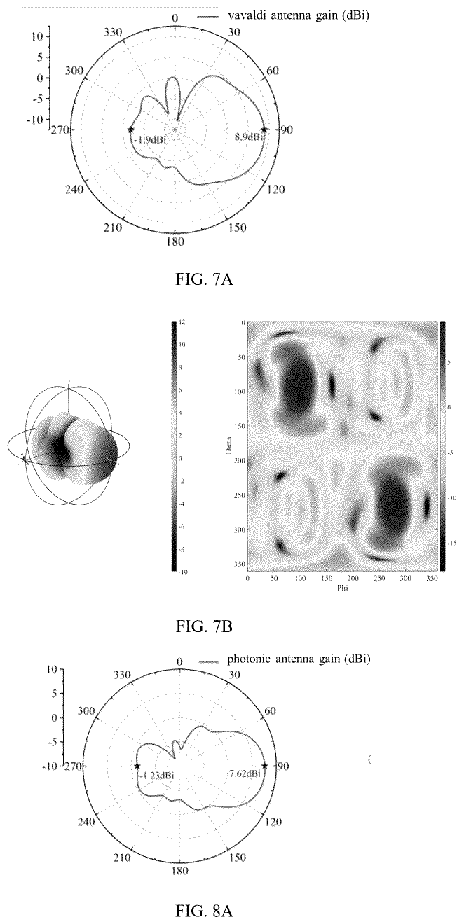

Step 4: A length L of the radiating structure 20 of the Vivaldi antenna 4 is 1.1 mm and the opening width W of the end of the radiating structure 20 is 0.65 mm. Thickness of metal layer is 2 μm. After optimizing, the back lobe gain of the Vivaldi antenna 4 is reduced to −1.9 decibels relative to an isotropic radiator (dBi), and the gain in a radiating direction reaches 8.9 dBi. An E-plane radiation pattern and a three-dimensional radiation pattern are shown in FIG. 7A and FIG. 7B.

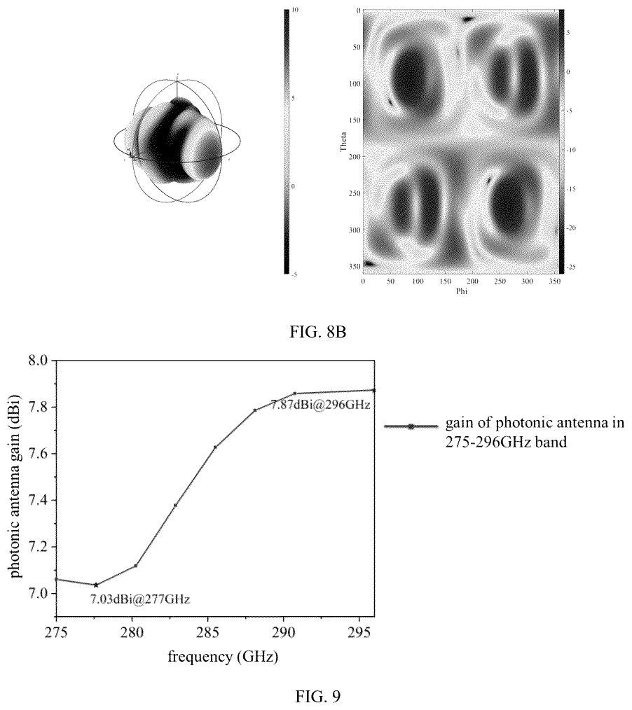

Step 5: The electrodes of the two UTC-PDs 1 with the same epitaxial structure are led out through electroplated micro-pads 25, metallic bumps 6 are formed on each of the micro-pads 25, and the UTC-PDs 1 are electrically connected to the passive structure fabricated on a quartz substrate 5 by flip-chip bonding. Simulation results indicate that the photonic antenna 34 achieves a gain of 7.62 dBi at 285 GHz. An E-plane radiation pattern and a three-dimensional radiation pattern are shown in FIG. 8A and FIG. 8B. In the range of 275-296 GHZ, the output gain remains above 7 dBi, and the gain-versus-frequency curve is shown in FIG. 9.

1. A photonic antenna operating in 275-296 gigahertz (GHz), comprising:
uni-traveling-carrier photodetectors (UTC-PDs); and
a passive structure, comprising impedance matching circuits, a power-combiner, and a Vivaldi antenna;
wherein the UTC-PDs are two in quantity, each UTC-PD adopts a double-mesa structure, the two identical UTC-PDs each have electrodes routed via electroplated micro-pads, with each electroplated micro-pad processed with metallic bumps, and the UTC-PDs are electrically connected to the passive structure fabricated on a quartz substrate by flip-chip bonding;
wherein the two UTC-PDs respectively correspond to the impedance matching circuits; the impedance matching circuits are two in quantity and arranged symmetrically; the impedance matching circuits are fabricated on the quartz substrate with a relative dielectric constant of 3.78; each impedance matching circuit comprises a serial transmission line, a short-circuited stub line, and a metal-insulator-metal (MIM) capacitor; and both the serial transmission line and the short-circuited stub line are implemented in coplanar waveguide configuration;
wherein the power-combiner is a T-junction power combiner used after the impedance matching circuits to superimpose two impedance-matched signals, where a first terminal and a second terminal of the power combiner respectively correspond to output terminals of the two impedance matching circuits;
wherein the T-junction power combiner comprises: the first terminal and the second terminal, a quarter-wavelength impedance transforming part, and a third terminal; and the Vivaldi antenna is connected to the third terminal of the T-junction power combiner, and the Vivaldi antenna is fed by a coplanar waveguide:
wherein the Vivaldi antenna comprises a feeding terminal, a radiating structure, and a reflecting structure;
wherein the feeding terminal adopts a coplanar waveguide structure that is identical to a structure of the third terminal of the T-junction power combiner; and
wherein the radiating structure comprises an exponentially changing open structure, radiating sheets of the Vivaldi antenna are defined with slots to enhance gain, and metal blocks are disposed at a middle position of the quartz substrate to direct; and the reflecting structure in an arc shape is formed on a rear surface of the quartz substrate to reduce a rear lobe gain and a side lobe gain.

2. The photonic antenna operating in 275-296 GHz as claimed in claim 1, wherein the double-mesa structure of each UTC-PD comprises: a P-type ohmic-contact layer, a barrier layer, an absorption layer, and a collection layer sequentially arranged in that order from top to bottom;
the barrier layer comprises a P-type indium phosphide (InP) barrier layer and a P-type indium gallium arsenide phosphide (InGaAsP) barrier layer;
the absorption layer comprises a P-type heavily-doped non-depleted indium gallium arsenide (InGaAs) absorption layer and a P-type doped depleted InGaAs absorption layer; the absorption layer is configured to introduce a built-in electric field through gradient-doping, and a concentration difference induces a potential difference to introduce an electric field to accelerate electrons transport through the absorption layer; and
the collection layer comprises an N-type doped InP cliff layer and an N-type lightly-doped InP collection layer; and the N-type doped InP cliff layer is configured to enhance the electric field in the absorption layer while reducing an electric field in the collection layer.

3. (canceled)

4. (canceled)

5. The photonic antenna operating in 275-296 GHz as claimed in claim 1, wherein a load impedance of each UTC-PD is adjusted and based on specific calculation formulas comprising:
an output impedance of each UTC-PD in a certain frequency band is: Z=m+j×n;
where m is resistance, n is reactance, and j is imaginary unit;
an impedance of each impedance matching circuit is: Z1=α+j×c;
where α is resistance, and c is reactance; and
impedance matching is calculated by: making the output impedance Z and the impedance Z1 satisfy: Z+Z1=50+j×0, that is, an output resistance of the UTC-PD with the impedance matching circuit superimposed in the certain frequency band is 50Ω and the reactance is zero.

6. (canceled)

7. The photonic antenna operating in 275-296 GHz as claimed in claim 1, wherein the T-junction power combiner has a length of 10 micrometers (μm) of each of the first terminal and the second terminal and a characteristic impedance of 50Ω; the quarter-wavelength impedance transforming part has a length of 177 μm and a characteristic impedance of 70.7Ω; and the third terminal has a length of 30 μm and a characteristic impedance of 50Ω.

8. (canceled)

9. The photonic antenna operating in 275-296 GHz as claimed in claim 1, wherein a width of each slot is 30 μm, a spacing between the slots is 100 μm, and a height of the slots decreases in units of 50 μm starting from 200 μm.

10. (canceled)
